(19) United States
(12) Patent Application Publication
(10) Pub. No.: US 2003/0218533 A1
(43) Pub. Date: Nov. 27, 2003

(54) Door access control system and associated methods

(76) Inventor: Kenneth E. Flick, Douglasville, GA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/153,101

(22) Filed: May 22, 2002

(51) Int. Cl. G05B 19/00

(52) U.S. Cl. 340/5.22

(57) ABSTRACT

An access control system for a building door switchable between locked and unlocked states includes at least one uniquely-coded token and a housing adjacent the building door. A token reader, controller and indicator are carried by the housing. The controller cooperates with the token reader for learning the at least one uniquely-coded token to define at least one learned uniquely-coded token, and for switching the building door between locked and unlocked states responsive to the at least one learned uniquely-coded token. The indicator cooperates with the controller for indicating whether a new uniquely-coded token has been learned to thereby alert the user of a potentially unauthorized learned uniquely-coded token for switching the building door between locked and unlocked states. A biometric characteristic of a user may be used in place of the token.

### FIELD OF THE INVENTION

The present invention relates to the field of security systems, and more particularly, to a door locking system for a building.

### BACKGROUND OF THE INVENTION

Building security devices are widely used to deter theft of valuables, and to create a greater sense of security for building occupants. One class of such security devices include self-contained devices mounted on the door which, in turn, are responsive to user codes to grant or deny access through the door. For example, U.S. Pat. No. 5,712,626 to Andreou et al. discloses a door locking mechanism that unlocks the door responsive to a remote transmitter. A separate programmer is used to program the door locking device and remote transmitter so that the two will work together.

A number of other keyless-type locking devices are also available, such as for example, the RadioKey 6″ Proximity Card Reader offered by the Keyless Lock Store of East Hills, N.Y. Such devices may operate an electrically powered door strike, or other door lock mechanism, to permit access through the door responsive to presentation of a radio transmitter, for example.

Along these lines, U.S. Pat. No. 5,650,774 to Drori discloses a remote control access system for vehicles or buildings wherein the code of a remote transmitter may be programmed or learned into the receiver. The receiver is first placed into a learning mode to learn the unique codes of the remote transmitter or transmitters.

Many types of electronic or keyless door access control devices permit the user to learn new transmitters into the controller, such as disclosed in the Drori patent. This provides significant user convenience should a transmitter be lost or a new transmitter simple be desired. Unfortunately, entry into the learning mode may be performed by an unauthorized person. In other words, the unauthorized person may learn a new transmitter into the controller of the access system. Thereafter the would-be-thief can return at any time to steal valuables from the building, for example. With conventional access control devices, the proper user would be unaware that the security has been compromised.

### SUMMARY OF THE INVENTION

In view of the foregoing background, it is therefore an object of the present invention to provide an access control system controlling unlocking of a building door with enhanced features to protect against unauthorized access.

This and other objects, features and advantages in accordance with the present invention are provided by an access control system for a building door switchable between locked and unlocked states. In some embodiments, the access control system may include uniquely-coded tokens to be carried by users. A housing is positioned adjacent the building door, and a token reader and a controller may be carried by the housing. The controller cooperates with the token reader for learning the uniquely-coded tokens to define learned uniquely-coded tokens. The controller may also switch the building door between locked and unlocked states responsive to the learned uniquely-coded tokens.

The access control system may further comprise an indicator carried by the housing that cooperates with the controller for indicating whether a new uniquely-coded token has been learned. This advantageously alerts the user of a potentially unauthorized learned uniquely-coded token for switching the building door between locked and unlocked states. The indicator may comprise a light, a visual display, a speech message generator, or an audible signal generator, for example.

The controller may be switchable to a learning mode, and the indicator and controller cooperate for indicating that the learning mode has been entered. The indicator and controller may cooperate for indicating when the learning mode has last been entered, and/or a passage of time since the learning mode has last been entered. In other embodiments, the controller may drive the indicator to indicate a number of learned uniquely-coded tokens, a change in a number of learned uniquely-coded tokens, and/or a change in a unique code of the at least one learned uniquely-coded token.

The uniquely-coded token may comprise a wireless transmitter and the token reader may comprise a wireless receiver. In other embodiments, the uniquely-coded token and token reader may comprise a passively powered transponder and a transponder reader, respectively. In yet other embodiments, the token may comprise a respective magnetic card, and the token reader may comprise a magnetic card reader. In still other embodiments, the token may comprise an electronic key, and the token reader may comprise an electronic key reader.

The controller may be resettable to remove a more recently learned uniquely-coded token and replace it with a previously learned uniquely-coded token. Accordingly, should the user determine that an unauthorized token has been learned, the unauthorized token can be deleted and the prior token(s) can be restored.

The indicator and controller may also cooperate to give the indication based upon a predetermined event. For example, the indication may be given based upon the token reader reading a uniquely-coded token, or upon a predetermined schedule. The uniquely-coded token may have a pseudorandom code portion for additional security.

The access control system may further comprise a battery carried by the housing that powers the token reader, controller, and indicator. An electrical actuator may also be carried by the housing, for switching the building door between locked and unlocked states.

A method aspect of the invention is for switching a building door between locked and unlocked states. The method may comprise providing at least one uniquely-coded token to be carried by a user, and providing adjacent the building door a token reader and a controller cooperating therewith for learning the at least one uniquely-coded token to define at least one learned uniquely-coded token. The controller may also be used for switching the building door between locked and unlocked states responsive to the at least one learned uniquely-coded token. In addition, the method may include indicating whether a new uniquely-coded token has been learned to thereby alert the user of a potentially unauthorized learned uniquely-coded token for switching the building door between locked and unlocked states.

In another embodiment of the invention, the access control system may include a housing adjacent the building door and a biometric characteristic sensor carried by the housing for sensing unique biometric characteristics of an individual. A controller may also be carried by the housing that cooperates with the biometric characteristic sensor for learning the unique biometric characteristics to define a learned individual. The access control system may also include an indicator carried by the housing. The indicator may cooperate with the controller for indicating whether a new individual has been learned to thereby alert a user of a potentially unauthorized learned individual for switching the building door between locked and unlocked states. In other words, in these embodiments, a biometric characteristic sensor is used instead of a token reader, and the biometric characteristic sensor senses a unique biometric characteristic of the user.

A method aspect of the second embodiment is also for switching the building door between locked and unlocked states. The method preferably includes providing adjacent the building door a biometric characteristic sensor for sensing at least unique one biometric characteristic of at least one individual and a controller cooperating therewith for learning the at least unique one biometric characteristic to define at least one learned individual. The method may also include using the controller to switch the building door between locked and unlocked states responsive to the at least one learned individual. In addition, the method may include indicating whether a new individual has been learned to thereby alert a user of a potentially unauthorized learned individual for switching the building door between locked and unlocked states.

### BRIEF DESCRIPTION OF THE DRAWINGS

FIG. 1 is a schematic diagram of an access control system for a building door according to the present invention.

FIG. 2 is a more detailed schematic block diagram of the access control system illustrated in FIG. 1.

FIG. 3 is a schematic block diagram of an alternate embodiment of a uniquely-coded token and associated token reader for use in the access control system of FIG. 1.

FIG. 4 is a schematic block diagram of another alternate embodiment of a uniquely-coded token and associated token reader for use in the access control system of FIG. 1.

FIG. 5 is a schematic block diagram of still another alternate embodiment of a uniquely-coded token and associated token reader for use in the access control system of FIG. 1.

FIGS. 6-12 are flow charts illustrating use of the access control system as shown in FIG. 1.

FIG. 13 is schematic block diagram of another embodiment of the access control system including a biometric characteristic sensor according to the present invention.

FIGS. 14-17 are flow charts illustrating use of the access control system of FIG. 13.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout and prime and multiple prime notation are used in alternate embodiments.

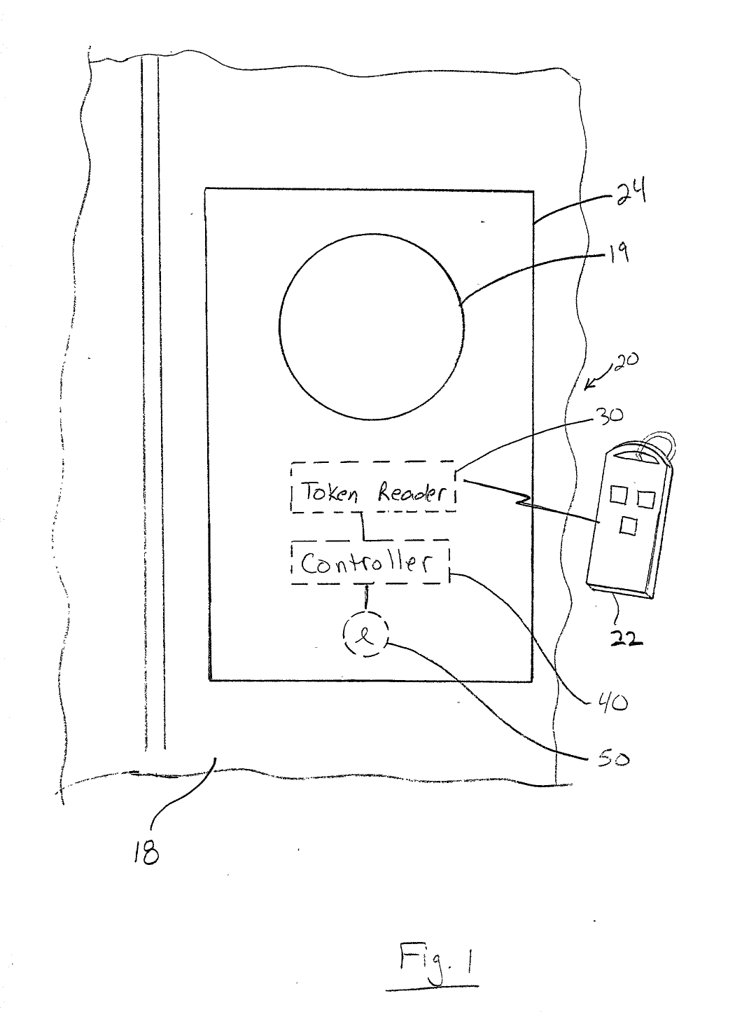

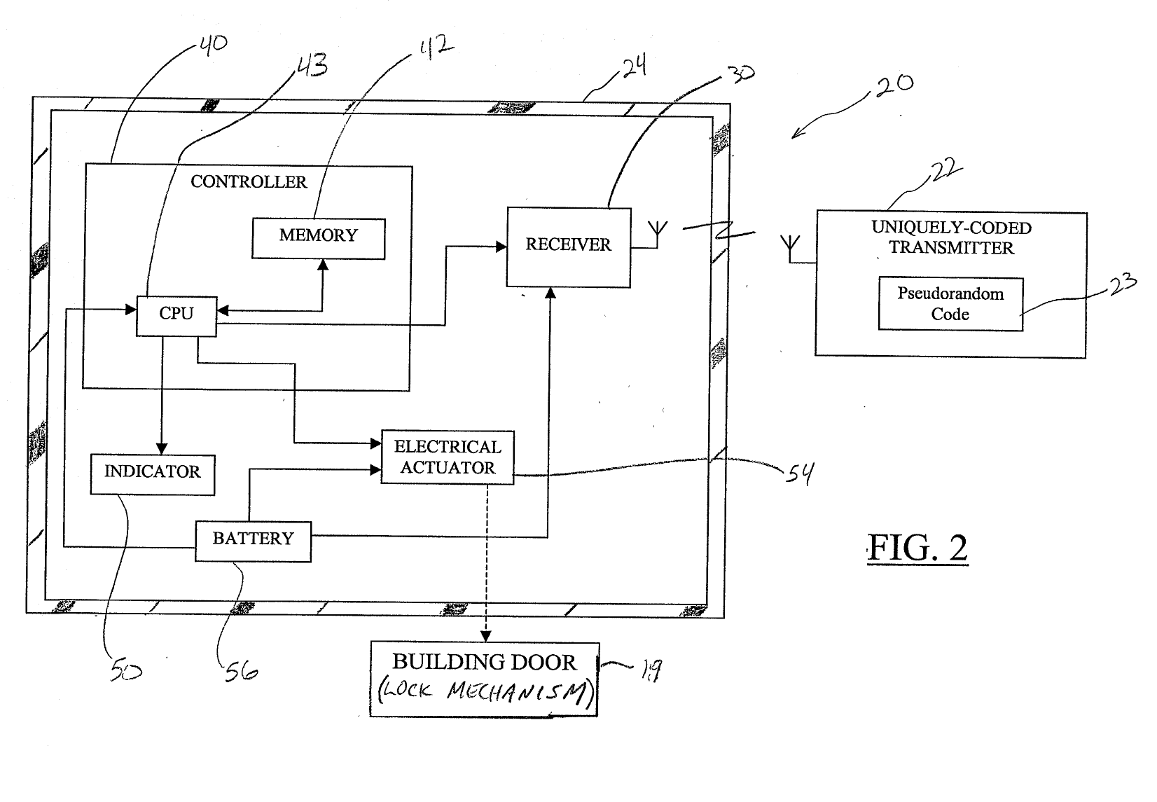

Referring initially to FIGS. 1 and 2, a door access control system 20 for a building door 18 according to one aspect of the invention is first described. The building door 18 is switchable between locked and unlocked states, such as by movement of a deadbolt, door strike, or other locking mechanism, not shown, as will be appreciated by those skilled in the art. In the unlocked state the door 18 may be opened manually or be opened by another actuator, for example.

The access control system 20 illustratively includes at least one uniquely-coded token 22 to be carried by a user, and a housing 24 adjacent the building door 18. The housing 24 is preferably placed adjacent a door handle or door knob 19 connected to the building door 18, but may also be placed anywhere adjacent the building door as understood by those skilled in the art. In some advantageous embodiments, the door handle or knob 19 may also be carried by the housing 24 as shown.

A token reader 30, controller 40, and indicator 50 are also illustratively carried by the housing 24. A uniquely-coded token 22 communicates with the token reader 30 to transmit the unique code of the uniquely-coded token. The indicator 50 may be a light emitting diode (LED) or other visible light, for example. In other embodiments, the indicator 50 may also be a visual display, a speech message generator, an audible signal generator, or any other type of indicator capable of providing an indication to a user.

The controller 40 cooperates with the token reader 30 for learning the uniquely-coded tokens 22 to define learned uniquely-coded tokens. The controller also switches the building door 18 between locked and unlocked states responsive to learned uniquely-coded tokens 22. The controller 40 illustratively includes a central processing unit (CPU) 42 and a memory 43 in communication therewith for performing the learning and operating functions as will be appreciated by those skilled in the art. The memory 43 stores a plurality of unique codes of the uniquely-coded tokens 22. Of course, the controller 40 may be switchable to a learning mode so that additional unique codes of may be stored in the memory 43.

The controller 40 may also be resettable to remove a more recently learned uniquely-coded token 22 and replace it with a previously learned uniquely-coded token. This code reset feature is similar to that described in U.S. Pat. Nos. 6,144,315 and 5,986,571, also to the present inventor, and the entire contents of which are incorporated herein by reference. Accordingly, this aspect requires no further discussion herein.

The indicator 50 cooperates with the controller 40 for indicating whether a new uniquely-coded token 22 has been learned to thereby alert the user of a potentially unauthorized learned uniquely-coded token for switching the building door 18 between locked and unlocked state. The indicator 50 and the controller 40, in some embodiments, cooperate for indicating that the learning mode has been entered. In other embodiments, the indication is an indication of when the learning mode has last been entered. In addition, the indication could be for progressively indicating a passage of time since the learning mode has last been entered.

In some other embodiments, an indication that the learning mode has been entered is provided by indicating a number of uniquely-coded tokens 22. Alternately, the indication may indicate a change in a number of learned uniquely-coded tokens, and/or a change in a unique code of the learned uniquely-coded tokens.

The indicator 50 and controller 40 may cooperate to give the indication based upon a predetermined event. For example, the controller 40 may cause the indicator 50 to give an indication based upon the token reader 30 reading a uniquely-coded token 22. All of the above referenced indications advantageously enhance the security of the access control system 20 by indicating to a user whether a new uniquely-coded token 22 has been added by an unauthorized person.

The access control system 20 also illustratively includes an electrical actuator 54 carried by the housing 24 for switching the building door lock mechanism 19 between locked and unlocked states. The access control system 20 also includes a battery 56 carried by the housing 24. The battery 56 is connected to the controller 40, the electrical actuator 54 and the token reader 30 for supplying electrical power thereto. Of course, in other embodiments, the circuitry could be powered from an AC supply, or the battery could be a back-up battery recharged from the AC supply.

In the embodiment illustrated in FIGS. 1 and 2, the uniquely-coded token 22 is a wireless transmitter and the token reader 30 is a wireless receiver. The uniquely-coded token 22 illustratively includes a pseudorandom code portion 17 for greater security against code grabbing, for example, as will be appreciated by those skilled in the art. In other words, the wireless transmitter includes at least a code portion that changes based upon pseudorandom coding that is synchronized with the reader 30.

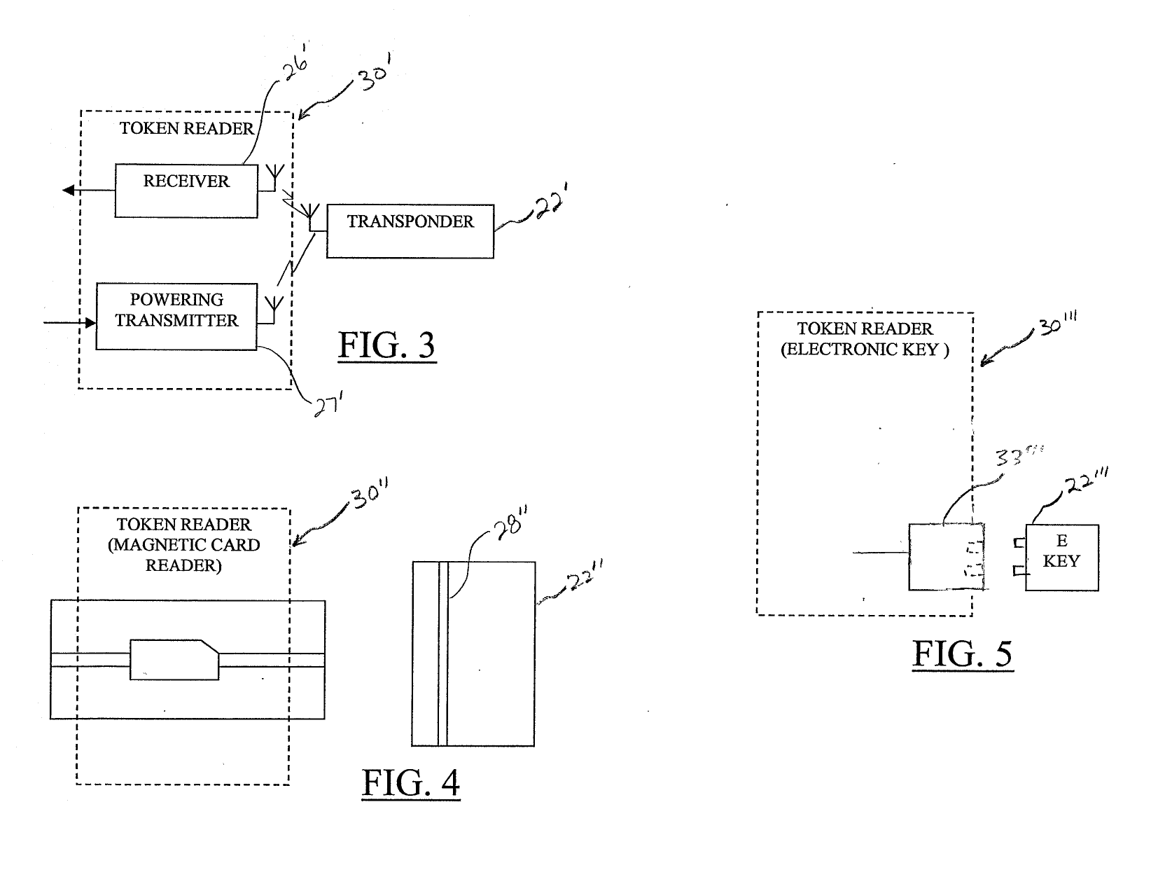

Turning now to FIG. 3, in a second embodiment the uniquely-coded token 22′ is illustratively provided by a passively powered transponder and the token reader 30′ is a transponder reader. The transponder reader includes a receiver 26′ for receiving a signal transmitted from the transponder and a powering transmitter 27′ for transmitting a powering signal to the transponder. The transponder transmits its signal upon being powered from the powering transmitter 27′ as will be readily appreciated by those skilled in the art.

Turning now additionally to FIG. 4, in this embodiment the uniquely-coded token 22″ illustratively comprises a magnetic card and the token reader 30″ illustratively comprises a magnetic card reader. The magnetic card illustratively includes a magnetic strip 28″ for storing at least one unique code as will also be appreciated by those skilled in the art.

In FIG. 5 yet another embodiment is shown, wherein the uniquely-coded token 22″′ illustratively comprises an electronic key and the token reader 30″′ comprises an electronic key reader. The electronic key reader illustratively includes a connector 33″′ for receiving the electronic key to make electrical contact therewith. The electronic key may be based upon an integrated circuit device, such as an iButton™ manufactured by Dallas Semiconductor, although other suitable devices known to those of skill in the art may be used.

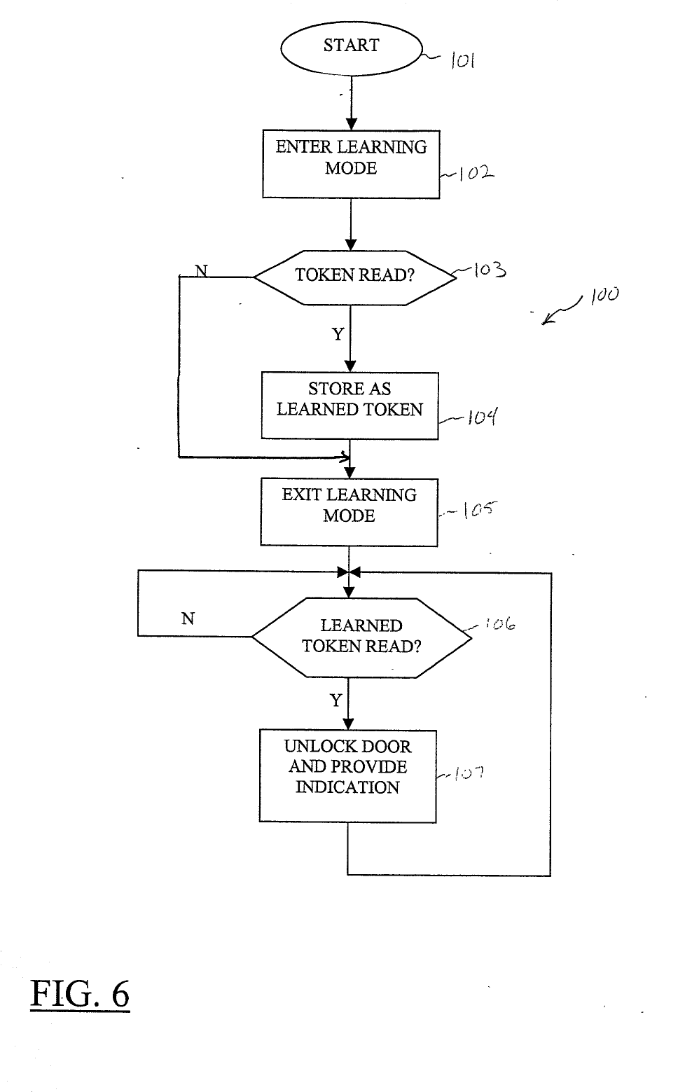

Turning now additionally to the flowchart 100 of FIG. 6, the learning mode feature of the present invention will further be discussed. From the start (Block 101), the controller 40 enters the learning mode at Block 102. The learning mode may be entered upon presentation of a token, by a predetermined sequence of operation of the door handle, or by a combination of the two, for example. Of course, other approaches to entering the learning mode are also contemplated by the present invention.

Once in the learning mode, at Block 103 it is determined whether a uniquely-coded token 22 has been read. If it is determined that a uniquely-coded token 22 has not been read, then the access control system 20 will exit the learning mode (Block 105), such as after a predetermined time. If, however, it is determined at Block 103 that a uniquely-coded 22 token has been read, then at Block 104 the uniquely-coded token is stored in the memory 43 as a learned uniquely-coded token. More than one token 22 may be so learned at a given time. The learning mode is exited at Block 105.

At Block 106, it is determined if a learned uniquely-coded token 22 is read. If, at Block 106, it is determined that a learned uniquely-coded token 22 has not been read, then the access control system 20 awaits the reading of a learned uniquely-coded token. If, however, it is determined at Block 106 that a learned uniquely-coded token 22 has been read, then the at Block 107, the building door 18 is unlocked and an indication is illustratively provided by the indicator 50. Of course, the indication can be given continuously, at another time, or based another predetermined event. The access control system 20 then awaits the reading of another learned uniquely-coded token 22.

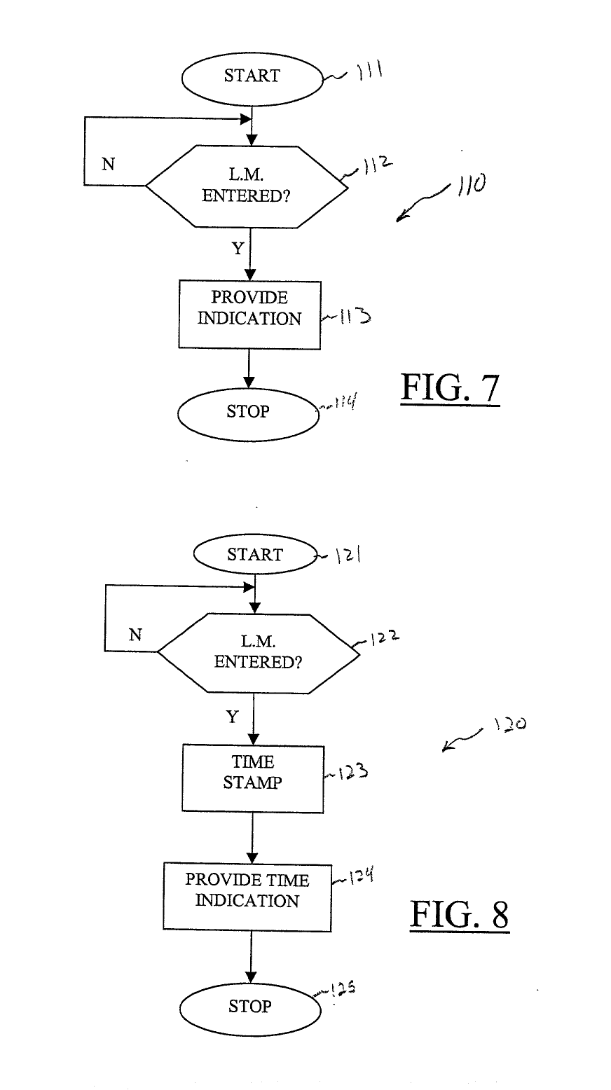

Turning now additionally to the flow chart 110 of FIG. 7, another aspect of the present invention is described. From the start (Block 111), it is determined at Block 112 whether the controller 40 has entered the learning mode. If it is determined that the controller 40 has not entered the learning mode, then the access control system 20 awaits the entering of the controller 40 into the learning mode. If, however, it is determined at Block 112 that the controller 40 has entered the learning mode, then at Block 113 the indicator 50 provides an indication that the controller 40 has entered the learning mode. The learning mode is then exited at Block 114. This could be continuous indication or an indication activated upon the subsequent reading of a token. The indication would alert the proper user that the learning mode has recently been entered, and possibly by an unauthorized person, for example.

Turning now additionally to the flow chart 120 of FIG. 8, from the start (Block 121), it is determined at Block 122 whether the controller 40 has entered the learning mode. If it is determined that the controller 40 has not entered the learning mode, then the access control system 20 awaits the entering of the controller 40 into the learning mode. If, however, it is determined at Block 122 that the controller 40 has entered the learning mode, then at Block 123 the time at which the controller 40 has entered the learning mode is recorded with a time stamp. At Block 124 the indicator provides an indication of the time that the controller 40 entered the learning mode before stopping at (Block 125). Again, the proper user can tell if the learning mode was entered by an unauthorized person.

Turning now additionally to the flow chart 130 of FIG. 9, from the start (Block 131), it is determined at Block 132 whether the controller 40 has entered the learning mode. If it is determined the controller 40 has not entered the learning mode then the access control system 20 awaits the entering of the controller 40 into the learning mode. If, however, it is determined at Block 132 that the controller 40 has entered the learning mode, then at Block 133 a timer is started. At Block 134 an indication of the elapsed time that the controller 40 since the learning mode was entered (or exited) is provided by the indicator before stopping at Block 135. Again, the proper user can tell if the learning mode was entered by an unauthorized person.

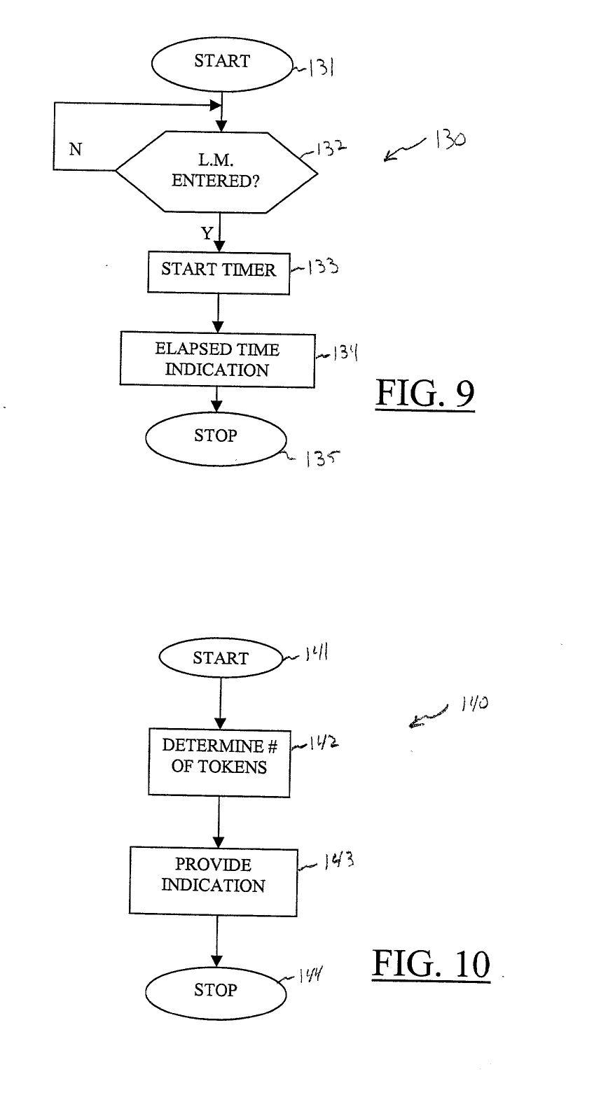

Turning now additionally to the flow chart 140 of FIG. 10, from the start (Block 141) the controller 40 determines the number of tokens 22 at Block 142. At Block 143 an indication of the number of uniquely-coded tokens 22 is provided before stopping at Block 144. This indication may be provided based upon any predetermined event, such as on a regular time schedule, or upon reading another token, for example.

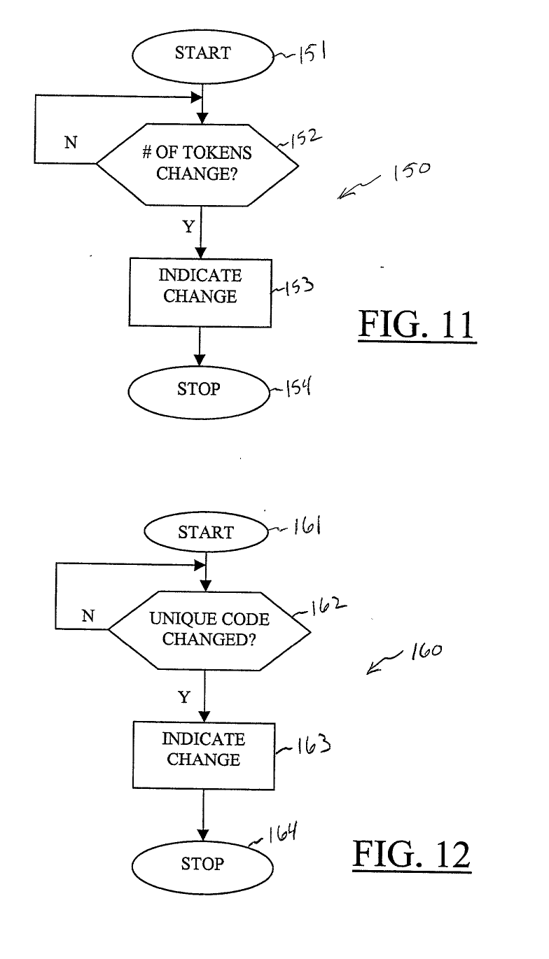

Turning now additionally to the flow chart 150 of FIG. 11, from the start (Block 151) it is determined at Block 152 whether the number of uniquely-coded tokens 22 has changed. If it is determined at Block 152 that the number of uniquely-coded tokens 22 has not changed, then the access control system 20 awaits a change in the number of uniquely-coded tokens. If, however, it is determined at Block 152 that the number of uniquely-coded tokens 22 has changed, then at Block 153 an indication is provided for the change before stopping at Block 154. For example, if there were three authorized tokens, and a fourth unauthorized token was learned, an indicator could flash four times and the proper user would be alerted that a fourth and unauthorized token had been learned.

Turning now additionally to the flow chart 160 of FIG. 12, from the start (Block 161), it is determined whether the unique code of one of the uniquely-coded tokens 22 has been changed at Block 162. If it is determined that the unique code has not been changed then the access control system 20 awaits a change in the unique code. If, however, it is determined at Block 162 that the unique code has been changed, then an indication of the change is provided at Block 163 before stopping at Block 164.

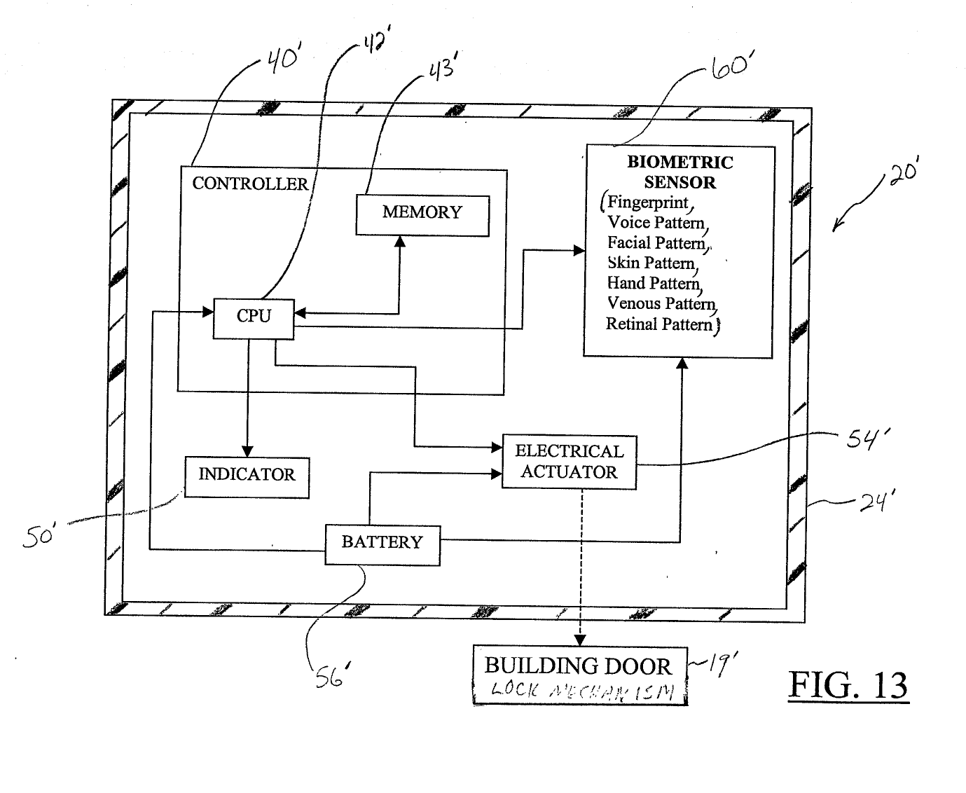

Turning now to FIG. 13, another embodiment of the access control system 20′ that includes a biometric characteristic sensor 60′ will now be described. The access control system 20′ illustrated in FIG. 13 is also for a building door 18 switchable between locked and unlocked states. The access control system 20′ comprises a housing 24′ adjacent the building door to operate the building door lock mechanism 19′.

The biometric characteristic sensor 60′, a controller 40′, and an indicator 50′, are illustratively carried by the housing 24′. The biometric characteristic sensor 60′ senses biometric characteristics of an individual. The biometric characteristic sensor 60′ may include one or more of a fingerprint sensor, a voice pattern sensor, a facial pattern sensor, a skin pattern sensor, a hand pattern sensor, a venous pattern sensor, and a retinal pattern sensor. Other biometric 60 sensors can also be used, however, as understood by those skilled in the art. Further information relating to biometric characteristic sensors and the user thereof may be found in U.S. Pat. No. 6,140,939 also to the present inventor and the entire disclosure of which is incorporated herein by reference.

The indicator 50′ may be at least one of a visual display, a speech message generator, an audible signal generator, or any other type of indicator capable of providing an indication to a user as understood by those skilled in the art. The controller 40′ cooperates with the biometric characteristic sensor 60′ for learning biometric characteristics to define learned individuals. The controller 40′ also switches the building door between locked and unlocked states responsive to the learned individual. The controller 40′ is switchable to a learning mode to learn additional biometric characteristics of individuals and is resettable to remove a more recently learned individual and replace it with a previously learned individual, as described above with respect to the uniquely-coded tokens.

The indicator 50′ cooperates with the controller 40′ for indicating whether a new individual has been learned to alert a user of a potential unauthorized learned individual for switching the building door 18′ between locked and unlocked states. For example, the indicator 50′ and controller 40′ may cooperate for indicating that the learning mode has been entered, when the learning mode has last been entered, and/or a passage of time since the learning mode has last been entered. The indication may also be for a number of learned individuals, and/or a change in the number of learned individuals, for example. Moreover, the indicator 50′ and controller 40′ may cooperate to give an indication based upon a predetermined event, such as the biometric characteristic sensor 60′ reading a biometric characteristic, or based upon a time schedule, for example.

The access control system 20′ illustratively includes an electrical actuator 54′ carried by the housing 24′. The electrical actuator 54′ advantageously switches the building door lock mechanism 19′ between locked and unlocked states. The access control system 20′ also illustratively includes a battery 56′ for powering the controller 40′, the biometric characteristic sensor 60′, and the electrical actuator 54′. An AC power supply may be used in other embodiments as discussed above.

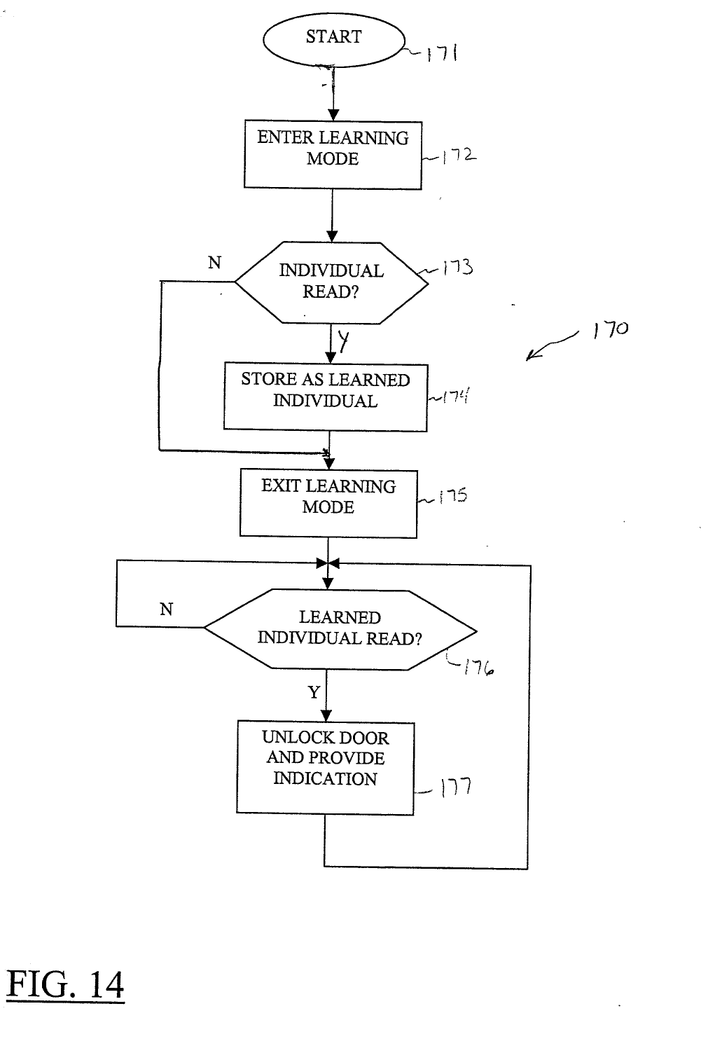

Turning now additionally to the flow chart 170 of FIG. 14 the operation of the access control system 20′ including the biometric characteristic sensor 60′ is now described. From the start (Block 171) the controller 40′ enters the learning mode at Block 172. At Block 173 it is determined whether or not an individual is read. If it is determined at Block 173 that an individual has not been read then the access control system 20′ may time out and exit the learning mode (Block 175). If, however, it is determined at Block 173 that the individual has been read, then at Block 174 the individual is stored into the memory 43′ as a learned individual. At Block 175 the controller 40′ exits the learning mode.

At Block 176 it is determined whether a learned individual is read. If it is determined that a learned individual has not been read, then the access control system 20′ awaits the reading of the individual. If, however, it is determined at Block 176 that a learned individual has been read, then the building door is unlocked and an indication is provided at Block 177. The access control system 20′ again awaits the reading of a learned individual.

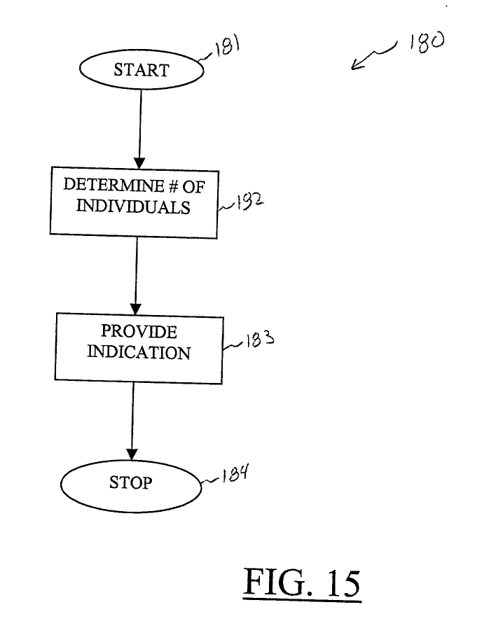

Turning now additionally to the flow chart 180 of FIG. 15, from the start (Block 181) the number of individuals is determined at Block 182. At Block 183 an indication of the number of learned individuals is provided before stopping at Block 184.

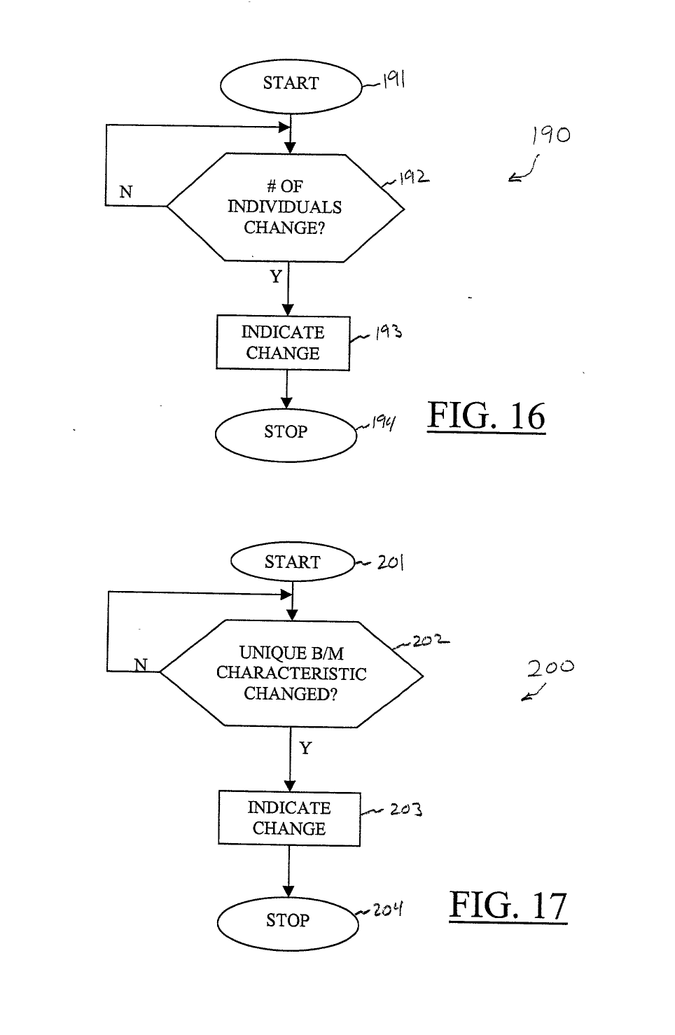

Turning now additionally to the flow chart 190 of FIG. 16, from the start (Block 191) it is determined at Block 192 whether the number of learned individuals has changed. If the number of learned individuals has not changed, then the access control system 20′ waits for a change in the number of individuals. If, however, it is determined at Block 192 that the number of individuals has changed then the change is indicated at Block 193 before stopping at Block 194.

Turning now additionally to the flow chart 200 of FIG. 17, yet another aspect of the indication feature is now described. From the start (Block 201) it is determined at Block 202 whether a unique biometric characteristic has been changed. If at Block 202 it is determined that a unique biometric characteristic has not been changed, then the access control system 20′ awaits a change in a biometric characteristic. If, however, at Block 202 it is determined that a unique biometric characteristic has been changed, then such a change is indicated at Block 203 before stopping at Block 204.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that other modifications and embodiments are intended to be included within the scope of the appended claims.

That which is claimed is:

1. An access control system for a building door switchable between locked and unlocked states, the access control system comprising:
at least one uniquely-coded token to be carried by a user;
a housing adjacent the building door;
a token reader carried by said housing;
a controller carried by said housing and cooperating with said token reader for learning the at least one uniquely-coded token to define at least one learned uniquely-coded token, and for switching the building door between locked and unlocked states responsive to the at least one learned uniquely-coded token; and
an indicator carried by said housing and cooperating with said controller for indicating whether a new uniquely-coded token has been learned to thereby alert the user of a potentially unauthorized learned uniquely-coded token for switching the building door between locked and unlocked states.

2. An access control system according to claim 1 wherein said controller is switchable to a learning mode; and wherein said indicator and controller cooperate for indicating that the learning mode has been entered.

3. An access control system according to claim 2 wherein said indicator and controller cooperate for indicating when the learning mode has last been entered.

4. An access control system according to claim 2 wherein said indicator and controller cooperate for progressively indicating a passage of time since the learning mode has last been entered.

5. An access control system according to claim 1 wherein said indicator and controller cooperate for indicating a number of learned uniquely-coded tokens.

6. An access control system according to claim 1 wherein said indicator and controller cooperate for indicating a change in a number of learned uniquely-coded tokens.

7. An access control system according to claim 1 wherein said indicator and controller cooperate for indicating a change in a unique code of the at least one learned uniquely-coded token.

8. An access control system according to claim 1 wherein said at least one uniquely-coded token comprises a wireless transmitter; and wherein said token reader comprises a wireless receiver.

9. An access control system according to claim 1 wherein said at least one uniquely-coded token comprises a passively powered transponder; and wherein said token reader comprises a transponder reader.

10. An access control system according to claim 1 wherein said at least one uniquely-coded token comprises a magnetic card; and wherein said token reader comprises a magnetic card reader.

11. An access control system according to claim 1 wherein said at least one uniquely-coded token comprises an electronic key; and wherein said token reader comprises an electronic key reader.

12. An access control system according to claim 1 wherein said controller is resettable to remove at least one more recently learned uniquely-coded token and replace it with at least one previously learned uniquely-coded token.

13. An access control system according to claim 1 wherein said indicator and controller cooperate to give the indication based a predetermined event.

14. An access control system according to claim 13 wherein the predetermined event comprises said token reader reading a uniquely-coded token.

15. An access control system according to claim 1 further comprising a battery carried by said housing and powering said token reader, controller and indicator.

16. An access control system according to claim 1 wherein said at least one uniquely-coded token has associated therewith a pseudorandom code.

17. An access control system according to claim 1 wherein said indicator comprises at least one of a light, a visual display, a speech message generator, and an audible signal generator.

18. An access control system according to claim 1 further comprising an electrical actuator carried by said housing for switching the building door between locked and unlocked states.

19. An access control system for a building door switchable between locked and unlocked states, the access control system comprising:
at least one uniquely-coded token to be carried by a user;
a housing adjacent the building door;
a token reader carried by said housing;
a controller carried by said housing and being switchable to a learning mode, said controller when in the learning mode cooperating with said token reader for learning the at least one uniquely-coded token to define at least one learned uniquely-coded token, said controller switching the building door between locked and unlocked states responsive to the at least one learned uniquely-coded token; and
an indicator carried by said housing and cooperating with said controller for indicating whether the learning mode has been entered to thereby alert the user of a potentially unauthorized learned uniquely-coded token for switching the building door between locked and unlocked states.

20. An access control system according to claim 19 wherein said indicator and controller cooperate for indicating when the learning mode has last been entered.

21. An access control system according to claim 19 wherein said indicator and controller cooperate for progressively indicating a passage of time since the learning mode has last been entered.

22. An access control system according to claim 19 wherein said controller is resettable to remove at least one more recently learned uniquely-coded token and replacing it with at least one previously learned uniquely-coded token.

23. An access control system according to claim 19 further comprising a battery carried by said housing and powering said token reader, controller and indicator.

24. An access control system according to claim 19 wherein said indicator and controller cooperate to give the indication based a predetermined event.

25. An access control system according to claim 19 further comprising an electrical actuator carried by said housing for switching the building door between locked and unlocked states.

26. An access control system for a building door switchable between locked and unlocked states, the access control system comprising:
at least one uniquely-coded token to be carried by a user;
a housing adjacent the building door;
a token reader carried by said housing;
a controller carried by said housing and being switchable to a learning mode, said controller when in the learning mode cooperating with said token reader for learning the at least one uniquely-coded token to define at least one learned uniquely-coded token, said controller switching the building door between locked and unlocked states responsive to the at least one learned uniquely-coded token; and
an indicator carried by said housing and cooperating with said controller for indicating a number of learned uniquely coded tokens whether the learning mode has been entered to thereby alert the user of a potentially unauthorized learned uniquely-coded token for switching the building door between locked and unlocked states.

27. An access control system according to claim 26 wherein said controller is resettable to remove at least one more recently learned uniquely-coded token and replacing it with at least one previously learned uniquely-coded token.

28. An access control system according to claim 26 wherein said indicator and controller cooperate to give the indication based a predetermined event.

29. An access control system according to claim 26 further comprising a battery carried by said housing and powering said token reader, controller and indicator.

30. An access control system according to claim 26 further comprising an electrical actuator carried by said housing for switching the building door between locked and unlocked states.

31. A method for switching a building door between locked and unlocked states comprising:
providing at least one uniquely-coded token to be carried by a user;
providing adjacent the building door a token reader and a controller cooperating therewith for learning the at least one uniquely-coded token to define at least one learned uniquely-coded token;
using the controller to switch the building door between locked and unlocked states responsive to the at least one learned uniquely-coded token; and
indicating whether a new uniquely-coded token has been learned to thereby alert the user of a potentially unauthorized learned uniquely-coded token for switching the building door between locked and unlocked states.

32. A method according to claim 31 further comprising switching the controller to a learning mode; and wherein indicating comprises indicating when the learning mode has been entered.

33. A method according to claim 32 wherein indicating comprises indicating a passage of time since the learning mode has last been entered.

34. A method according to claim 31 wherein indicating comprises indicating a number of learned uniquely-coded tokens.

35. A method according to claim 31 wherein indicating comprises indicating a change in a number of learned uniquely-coded tokens.

36. A method according to claim 31 wherein the at least one uniquely-coded token comprises a wireless transmitter; and wherein the token reader comprises a wireless receiver.

37. A method according to claim 31 wherein the at least one uniquely-coded token comprises a passively powered transponder; and wherein the token reader comprises a transponder reader.

38. A method according to claim 31 wherein the at least one uniquely-coded token comprises a magnetic card; and wherein the token reader comprises a magnetic card reader.

39. A method according to claim 31 wherein the at least one uniquely-coded token comprises an electronic key; and wherein the token reader comprises an electronic key reader.

40. A method according to claim 31 further comprising removing at least one more recently learned uniquely-coded token and replacing it with at least one previously learned uniquely-coded token.

41. An access control system for a building door switchable between locked and unlocked states, the access control system comprising:
a housing adjacent the building door;
a biometric characteristic sensor carried by said housing for sensing at least one unique biometric characteristic of at least one individual;
a controller carried by said housing and cooperating with said biometric characteristic sensor for learning the at least one unique biometric characteristic to define at least one learned individual, and for switching the building door between locked and unlocked states responsive to the at least one learned individual; and
an indicator carried by said housing and cooperating with said controller for indicating whether a new individual has been learned to thereby alert a user of a potentially unauthorized learned individual for switching the building door between locked and unlocked states.

42. An access control system according to claim 41 wherein said controller is switchable to a learning mode; and wherein said indicator and controller cooperate for indicating that the learning mode has been entered.

43. An access control system according to claim 42 wherein said indicator and controller cooperate for indicating when the learning mode has last been entered.

44. An access control system according to claim 42 wherein said indicator and controller cooperate for progressively indicating a passage of time since the learning mode has last been entered.

45. An access control system according to claim 41 wherein said indicator and controller cooperate for indicating a number of learned individuals.

46. An access control system according to claim 41 wherein said indicator and controller cooperate for indicating a change in a number of learned individuals.

47. An access control system according to claim 41 wherein said biometric characteristic sensor is at least one of a fingerprint sensor, a voice pattern sensor, a facial pattern sensor, a skin pattern sensor, a hand pattern sensor, a venous pattern sensor, and a retinal pattern sensor.

48. An access control system according to claim 41 wherein said controller is resettable to remove at least one more recently learned individual and replace it with at least one previously learned individual.

49. An access control system according to claim 41 wherein said indicator and controller cooperate to give the indication based upon a predetermined event.

50. An access control system according to claim 49 wherein the predetermined event comprise reading a biometric characteristic.

51. An access control system according to claim 41 further comprising a battery carried by said housing and powering said biometric sensor, controller and indicator.

52. An access control system according to claim 41 wherein said indicator comprises at least one of a light, a visual display, a speech message generator, and an audible signal generator.

53. An access control system according to claim 41 further comprising an electrical actuator carried by said housing for switching the building door between locked and unlocked states.

54. A method for switching a building door between locked and unlocked states comprising:
providing adjacent the building door a biometric characteristic sensor for sensing at least unique one biometric characteristic of at least one individual and a controller cooperating therewith for learning the at least unique one biometric characteristic to define at least one learned individual;
using the controller to switch the building door between locked and unlocked states responsive to the at least one learned individual; and
indicating whether a new individual has been learned to thereby alert a user of a potentially unauthorized learned individual for switching the building door between locked and unlocked states.

55. A method according to claim 54 further comprising switching the controller to a learning mode; and wherein indicating comprises indicating when the learning mode has been entered.

56. A method according to claim 54 further comprising switching the controller to a learning mode; and wherein indicating comprises indicating a passage of time since the learning mode has last been entered.

57. A method according to claim 54 wherein indicating comprises indicating a number of learned individuals.

58. A method according to claim 54 wherein indicating comprises indicating a change in a number of learned individuals.

59. A method according to claim 54 wherein indicating comprises indicating based upon a predetermined event.

60. A method according to claim 59 wherein the predetermined event comprises the biometric characteristic sensor reading a biometric characteristic.

61. A method according to claim 54 further comprising removing at least one more recently learned individual and replacing it with at least one previously learned individual.

62. A method according to claim 54 wherein the biometric characteristic sensor is at least one of a fingerprint sensor, a voice pattern sensor, a facial pattern sensor, a skin pattern sensor, a hand pattern sensor, a venous pattern sensor, and a retinal pattern sensor.
